(19) United States
(12) Patent Application Publication
(10) Pub. No.: US 2025/0340454 A1
(43) Pub. Date: Nov. 6, 2025

(54) METHOD FOR DETERMINING THE REMAINING WATER VOLUME IN A WATER SOFTENING SYSTEM USING H+/(NA+ AND/OR K+)-ION EXCHANGE RESINS

(71) Applicant: BRITA SE, Taunusstein (DE)

(72) Inventors: Peter WEIDNER, Rötz (DE); Berthold CONRADT, Wiesbaden (DE)

(21) Appl. No.: 18/855,532

(22) PCT Filed: Apr. 5, 2023
(86) PCT No.: PCT/EP2023/059015

§ 371 Date: Oct. 9, 2024

(30) Foreign Application Priority Data
Apr. 12, 2022 (DE) 10 2022 108 929.0

(51) Int. Cl. C02F 1/00; B01J 47/14; C02F 1/42

(52) U.S. Cl. CPC C02F 1/008; B01J 47/14; C02F 1/42; C02F 2001/425; C02F 2209/006; C02F 2209/05; C02F 2209/06; C02F 2209/40; C02F 2209/445

(57) ABSTRACT

A method of determining the remaining water volume (RLV) which can still be softened prior to the exhaustion of an ion exchange resin contained in a filter device. A water softening system, a computer program and a computer readable medium having stored thereon the computer program.

### FIELD OF THE INVENTION

The invention relates to a method for operating a water softening system with a softening device comprising an ion exchange material, specifically a H⁺/(Na⁺ and/or K⁺)-exchange resin, the method comprising measuring a water characteristic like filtrate pH or conductivity and volume and determining the remaining water volume which can still be softened prior to exhaustion of the exchange resin, from the filtrate pH or conductivity vs. volume data. The invention also relates to a water softening system including an electronic control unit as well as a computer program and a computer readable medium having stored thereon the computer program.

### BACKGROUND OF THE INVENTION

Systems and methods for softening water are generally known in the art. One of the most common methods employs an ion exchange resin which replaces the alkaline earth metal ions, specifically calcium (Ca²⁺) and magnesium ions (Mg²⁺), with sodium ions (Na⁺). In some devices the raw water supply is divided into two streams, one stream which passes over the ion exchange resin and another one which bypasses the ion exchange resin; the two streams are then blended in a pre-determined ratio to result in a softened water of pre-determined and desired total hardness.

Thus, in order to determine the blend ratio in water softening devices and/or in order to determine the exhaustion point of an ion exchange resin one needs to know the total water hardness of the raw water used in the water softening system. Once it is known how many equivalents of alkali earth metal ions need to be replaced by Na⁺/H⁺ one can calculate the exhaustion point of an ion exchange resin, the total Na⁺/H⁺ loading (capacity) of which is known, and likewise one can calculate the blending ratio of raw to filtered water in order to obtain a desired target water hardness which is lower than the raw water hardness.

Many systems measure the electrical conductivity or the electrical resistance of the raw and/or filtered water and correlate the conductivity/resistance to the total water hardness.

### PRIOR ART

To control the blending device in DE 10 2007 059 058 C5 a total hardness II of the raw water is derived from the measured conductivity of the raw water by means of a calibration curve (F2), as well as the conductivity of partial streams “V(t)partlsoft” and “V(t)part2raw”. The regeneration of the exchange resin is triggered on the basis of a total hardness I of the raw water, which is derived from the measured conductivity of the raw water by means of a calibration curve (F1), based on the untreated water flowed through the ion exchange resin and based on a stored capacity of the ion exchange resin.

EP 2 228 129 A1 discloses a method for the proper performance of a regeneration of a softening device of a water softening system wherein the conductivity of the spent regenerant solution and/or the rinsing water is determined in the flushing channel during regeneration by means of a conductivity sensor, and is compared with a stored nominal conductivity profile.

DE 10 2011003326 B4 discloses the control of the regeneration or signaling of the exhaustion of an ion exchange material and/or the automatic control of a blending device as a function of the total hardness G of the softened water which method comprises the following steps:
1) determination of the electrical conductivity LF of the raw water by means of a first conductivity sensor;
2) determining a total hardness G of the raw water from the electrical conductivity LF of the raw water by comparison with a stored calibration curve;
β) determining the electrical conductivity LF of the softened water by means of a second conductivity sensor;
4) determining the total hardness G of the softened water from the electrical conductivity LF of the softened water by comparison with a second stored calibration curve.

WO 2014/006129 discloses a method and an apparatus for determining the hardness of water. Water is separated into two portions. One portion is treated in an ion exchanger while the other portion bypasses the treatment unit. Both portions are mixed together again to obtain water of defined hardness. The conductivity of the water for different blending ratios is determined and the change of conductivity with the blending ratio is used to determine a conversion factor for the conversion of conductivity values into hardness values.

EP-B 2 870 473 describes the determination of a conversion factor relating to the conductivity and the hardness of water. The method comprises obtaining at least two conductivity values wherein the conductivity values pertain to measurements carried out on water at different ratios of untreated water to water led through a water treatment part; obtaining a difference conductivity value representative of a change in the conductivity due to water treatment; and converting the difference value into a water hardness value.

### SUMMARY OF THE INVENTION

While some prior art softening devices use the electrical conductivity for the determination of total water hardness which determination requires a calibration with a calibration curve, in general there does not exist a correlation between the electrical conductivity and total water hardness/resin life time. If one were to use linear regression to model measured data (GH vs. LF; see FIG. 1) a thereon based prediction would result in miscalculating the resin life time by a factor of about ⅓^{rd} for about ⅓^{rd} of the total number of measurements. Thus, there is a need for a more reliable determination and/or prediction of the life time of the exchange resin (exhaust time). A further need, which is associated with the determination/prediction of the life time of the exchange resin, and which is even more important to the user of the softening device, is the determination/prediction of the remaining water volume which can still be softened prior to the exhaustion of the exchange resin.

### BRIEF DESCRIPTION OF THE INVENTION

The above needs/objects are achieved by a method of determining the remaining water volume (RLV) which can still be softened prior to the exhaustion of an ion exchange resin contained in a filter device, the determination comprising the steps of:
i) sequentially measuring a water characteristic w, wherein w is selected from one or more of pH and electrical conductivity LF, and wherein w is determined by a sensor in softened water obtained from the filter device, at increments of softened volume (V_{S}) to acquire measured data points (V_{Si}, wᵢ) with i=1, 2, 3, . . . , N and N ∈ [symbol] ;
ii) after each measuring of a sequential data point (V_{Si}, wᵢ) in step i) which data point is defined as new data point, a polynomial is approximated between all previously measured data points (V_{Sp}, wₚ) with p=1, 2, . . . i-1, and the new data point (V_{Si}, wᵢ);
iii) after each polynomial approximation in step ii), the polynomial is analyzed for an inflection point IP (V_{IP}, w_{IP}) which corresponds to a point:
   α) (V_{Si}, w_{app_i}) of the polynomial being a point approximated for (V_{Si}, wᵢ) in step ii), wherein at point (V_{Si}, w_{app_i}), a difference Δw between w_{app_1} of point (V_{Si}, w_{app_S1}) of the polynomial being a point approximated for (V_{Si}, wᵢ) in step ii) and w_{app_i} of point (V_{Si}, w_{app_i}) of the polynomial is ≥50 μS/cm for w being electrical conductivity LF or is 1.5 for w being pH; or
   β) where the second derivative of the polynomial is 0 or where there is a change of sign of the second derivative from positive to negative or from negative to positive;
iv) repeating steps ii) and iii) with the next higher i, and when an inflection point is determined in step iii), RLV is calculated based on V_{IP} of the inflection point IP, by a water softening system including an electronic control unit, comprising
I. An inlet for influent raw water and
II. an outlet for effluent softened water,
III. a filter device containing an ion exchange resin,
IV. an electronic device capable of receiving signals emitted
   a. by a sensor for measuring the water characteristic w, arranged in the softened water outlet which signal is selected from one or more of the electrical conductivity (LF) and the pH,
   b. by a volume meter for measuring the volume flow of softened water likewise arranged in the softened water outlet which signal is the flowed softened water volume (V_{S}), which volume meter is optionally coupled with an hour and/or minute meter,
V. an interface for transmitting the signals received under IVa) and IVb) to an electronic control unit, and
VI. the electronic control unit,
, wherein the electronic control unit has a memory to:
I. store the repeatedly/sequentially measured water characteristic w, which is selected from one or more of the electrical conductivity LF and the pH of the filtered (i.e. softened) water at increments of softened water volume (V_{S}), received from the interface to acquire measured data points (V_{Si}, wᵢ) with i=1, 2, 3, . . . , N and N ∈ [symbol] ; and
II. store an executable computer program which is capable of executing the following method steps:
   a. after each storing of a sequential data point (V_{Si}, wᵢ) in step I) which data point is defined as new data point, approximating a polynomial between all previously measured data points (V_{Sp}, wₚ) with p=1, 2, . . . i-1, and the new data point (V_{Si}, wᵢ);
   b. after each polynomial approximation in step IIa), analyzing the polynomial for an inflection point IP (V_{IP}, w_{IP}) which corresponds to a point:
      α) (V_{Si}, w_{app_i}) of the polynomial being a point approximated for (V_{Si}, wᵢ) in step ii), wherein at point (V_{Si}, w_{app_i}), a difference Δw between w_{app_1} of point (V_{Si}, w_{app_S1}) of the polynomial being a point approximated for (V_{Si}, w₁) in step ii) and w_{app_i} of point (V_{Si}, w_{app_i}) of the polynomial is ≥50 μS/cm for w being electrical conductivity LF or is ≥1.5 for w being pH;
      β) where the second derivative of the polynomial is 0 or where there is a change of sign of the second derivative from positive to negative or from negative to positive;
   c. repeating steps Ila) and IIb) with the next higher i, and when an inflection point is determined in step IIb), RLV is calculated based on V_{IP} of the inflection point IP, by a computer program comprising instructions to cause a water softening system to execute the steps of the method and by a computer readable medium having stored thereon the computer program.

The method according to the invention comprises the following steps:
i) sequentially measuring a water characteristic w, wherein w is selected from one or more of pH and electrical conductivity LF, and wherein w is determined by a sensor in softened water obtained from the filter device, at increments of softened water volume (V_{S}) to acquire measured data points (V_{Si}, wᵢ) with i=1, 2, 3, . . . , N and N ∈ [symbol] ;
ii) after each measuring of a sequential data point (V_{Si}, wᵢ) in step i) which data point is defined as new data point, a polynomial is approximated between all previously measured data points (V_{Sp}, wₚ), with p=1, 2, . . . i-1, and the new data point (V_{Si}, wᵢ);
iii) after each polynomial approximation in step ii), the polynomial is analyzed for an inflection point IP (V_{IP}, w_{IP}) which corresponds to a point:
   α) (V_{Si}, w_{app_i}) of the polynomial being a point approximated for (V_{Si}, wᵢ) in step ii), wherein at point (V_{Si}, w_{app_i}), a difference Δw between w_{app_1} of point (V_{Si}, w_{app_S1}) of the polynomial being a point approximated for (V_{Si}, wᵢ) in step ii) and w_{app_i} of point (V_{Si}, w_{app_i}) of the polynomial is 50 μS/cm for w being electrical conductivity LF or is ≥1.5 for w being pH; or
   β) where the second derivative of the polynomial is 0 or where there is a change of sign of the second derivative from positive to negative or from negative to positive;
iv) repeating steps ii) and iii) with the next higher i, and when an inflection point is determined in step iii), RLV is calculated based on V_{IP} of the inflection point IP.

### Definition of Terms

Within the meaning of the present invention the following terms in quotation marks, whether used in singular or plural form, shall have the following meaning:

“Inflection Point” (IP) corresponds to a point indicating that the ion exchange resin contained in the filter device has a significantly decreased remaining filter capacity in the form of RLV. For example, for a weakly acidic ion exchange resin having a H⁺/(Na⁺ and/or K⁺)-loading, V_{IP} is the volume of softened water at which the exchange of alkaline earth metal ions such as Ca²⁺ and Mg²⁺ by means of Na⁺ and/or K⁺ is significantly decreased, such that the exchange by means of H⁺ increases, which results in a decrease of LF and pH. This decrease of LF and pH surprisingly allows a reliable determination of the inflection point (IP), wherein IP in turn allows calculation of the remaining water volume (RLV) which can still be softened prior to exhaustion of the ion exchange resin contained in a filter device.

“Raw water” or “RW” means water before it is subjected to a softening process.

“Softened water” or “filtered water” or “filtrate” means water which has been subjected to softening.

“Ion exchange resin”, “exchange resin”, “Ion exchange material”, “ion exchangers” or “exchange material” means a resin or polymer that acts as a medium for ion exchange. It is an insoluble matrix (or support structure) normally in the form of small (0.15-0.8 mm radius) microbeads made from an organic polymer substrate. The beads are typically porous, providing a large surface area on and inside them. The trapping of ions occurs along with the accompanying release of other ions, and thus the process is called ion exchange. There are multiple types of ion-exchange resins. Typical commercial resins are e.g. based on a polyacrylic matrix or are made of polystyrene sulfonate (see e.g. https://en.wikipedia.org/wiki/ion-exchange_resin).

“Exhaustion Time”, “exhaustion point”, “life time”, “depletion time”, “depletion point” means the point in time when the ion exchange resin is no longer capable of substituting the metal cations in the raw water with sodium and/or potassium ions and/or protons. Rather than indicating a point in time this can also be expressed as the amount (i.e. volume) of water which can be softened before the ion exchange resin is no longer capable of substituting the metal cations in the raw water with sodium and/or potassium ions and/or protons. This point of incomplete water softening is also known as “hardness breakthrough”.

“Remaining water volume” abbreviated as “RLV” herein, means the remaining water volume which can still be softened prior to the exhaustion time/point of the ion exchange resin.

“Remaining filter time” or “remaining filter life time” abbreviated as “RLZ” herein, means the remaining time that the ion exchange resin is still capable of softening the raw water prior to the exhaustion of the exchange resin.

“Total hardness” or “total water hardness”, abbreviated as “GH” herein, is usually caused by the presence of calcium sulfate/calcium chloride and/or magnesium sulfate/magnesium chloride in the water. The total water hardness is the sum of the molar concentrations of Ca²⁺ and Mg²⁺ and is expressed as dGH or ° dH. Conversions from dGH or ° dH into e.g. mmol/I or other units for permanent hardness can be taken from https://en.wikipedia.org/wiki/Hard_water.

“Temporary hardness”, “temporary water hardness”, “carbonate hardness”, abbreviated as “KH” herein, is a type of water hardness caused by the presence of dissolved bicarbonate minerals like calcium bicarbonate and magnesium bicarbonate. When dissolved, these type of minerals yield calcium and magnesium cations (Ca²⁺, Mg²⁺) and carbonate and bicarbonate anions (CO₃²⁻ and HCO₃⁻). The carbonate water hardness is expressed as dKH or ° dH. One dKH is equal to 17.848 mg/l CaCO₃ (see https://en.wikipedia.org/wiki/Carbonate_hardness).

“Permanent hardness” or “permanent water hardness”, abbreviated as “PH” herein, is GH minus KH.

“Ea²⁺” means alkaline earth metal ion, specifically, Ca²⁺ and/or Mg²⁺.

“LF” means electrical conductivity.

The “sensor” of step i) may be any conventional sensor capable of measuring pH or electrical conductivity LF of water. This sensor for determining the water characteristic w may be arranged in the softened water outlet of the filter device.

Further, in step i), the increments of softened water (V_{S}) in the form of V_{S1} with i=1, 2, 3, . . . , N and N ∈ [symbol] may be measured by a volume meter arranged in a softened water outlet of the filter device. The volume meter may optionally be coupled with an hour or minute meter.

### BRIEF DESCRIPTION OF THE DRAWINGS

FIG. 1 is a graph of GH vs. conductivity for Na⁺/H⁺ exchange resins;

FIG. 2 illustrates a LF vs. softened water volume curve;

FIG. 3 is a graph plotting filtrate conductivity vs. filtrate volume;

FIG. 4 is a further graph illustrating filtrate conductivity vs. filtrate volume;

FIG. 5 is a further graph illustrating filtrate conductivity vs. filtrate volume;

FIG. 6 depicts a flowchart of a particularly preferred determination of the inflection point IP.

FIG. 7 is a further graph illustrating filtrate conductivity vs. filtrate volume;

FIG. 8 is a further graph illustrating filtrate conductivity vs. filtrate volume; and

FIG. 9 depicts a flowchart of an alternative determination for the inflection point IP.

### DETAILED DESCRIPTION OF THE INVENTION

The invention relates to a method for operating a water softening system with a softening device comprising an ion exchange material, specifically a (Na⁺ and/or K⁺)/H⁺-exchange resin. In the softening process the hardness-forming ions, calcium and magnesium ions, are replaced with sodium and/or potassium ions, and/or protons. This ion exchange is performed by means of a resin (ion exchange resin) loaded with sodium and/or potassium ions and protons. In the following, sometimes only the terms “Na⁺/H⁺-exchange resin” and “Na⁺/H⁺ loading ratio” are exemplary used, because “Na⁺/H⁺-exchange resin” and “Na⁺/H⁺ loading ratio” are preferred. However, it is noted that generally, also “(Na⁺ and/or K⁺)/H⁺-exchange resin” and (Na⁺ and/or K⁺)/H⁺ loading ratio” may be applied, since in the present method, potassium ions (K⁺) provide for similar conductivity values in water like sodium ions (Na⁺).

The point in time when the ion exchange resin has matured to exhaustion depends on the nominal capacity of the ion exchange resin, on the water quality (i.e., the GH and/or KH of the raw water), and on the water consumption. Under the framework of the present invention LF measurements with Na⁺/H⁺ exchange resins have been performed. It was found that there is no direct correlation between conductivity and total hardness (see FIG. 1; GH vs. LF). If one would use a linear regression of the plotted data (total hardness vs. conductivity) this would result in a miscalculation of the exhaustion time by a factor of about ⅓^{rd} for about ⅓^{rd} of the total number of measurements (see FIG. 1). The ion exchange processes and the impact of these processes on the electrical conductivity (LF) of water which has passed an ion exchange resin with Na⁺ as well as H⁺ donor ions are complex.

Na⁺/H⁺ ion exchange resins—for example those of the polyacrylic type—are “weakly acidic” ion exchangers (due to the pending —COOH groups). In these weakly acidic ion exchangers the H⁺ ion is energetically favored (because smaller) over the Na⁺ ion (because larger). These types of ion exchange resins therefore prefer the exchange of Na⁺ for Ca²⁺ or Mg²⁺, and only very “reluctantly” release H⁺. Thus total hardness (GH), e.g. CaSO₄ in the water is exchanged to yield Na₂SO₄, and carbonate hardness (KH), e.g. Ca(HCO₃)₂→2 NaHCO₃, are exchanged. Yet, these exchange processes do not lead to a sufficiently significant change in conductivity (LF), since the limiting conductivities of Ca²⁺, Mg²⁺ and Na⁺ are about the same.

In order to be able to draw any conclusions about the state of a weakly acidic ion exchange resin from the LF, exchange reactions need to be taken into account that affect LF. The first reaction of this kind is the exchange of H⁺ for Ca²⁺ and Mg²⁺. As stated above, this rarely happens unless another element in the water has a higher affinity to H⁺ than the exchange resin itself. This applies to KH. The exchange of e.g. Ca²⁺ (Ca(HCO₃)₂→2 H₂CO₃) takes place because HCO₃⁻ has a higher affinity to H⁺ than the exchange resin. Thus KH is capable of reducing LF, since carbonic acid is formed which is only weakly dissociated. Ions that contribute to LF (e.g. Ca²⁺, Mg²⁺) are thus removed from the water and neutral molecules (H₂CO₃) that do not contribute to the LF are formed. However, as long as the exchange resin can release Na⁺ and/or K⁺ in abundance, i.e. as long as the resin is still loaded with Na⁺ and/or K⁺, the exchange remains neutral from the LF point of view. Only towards the end of the service life of the weakly acidic ion exchange resin, when the Na⁺ and/or K⁺ loading decreases, the H⁺ exchange increases, resulting in a decrease of LF and pH, which decrease allows the determination of the inflection point (IP). It is thus evident that the (Na⁺ and/or K⁺)/H⁺ loading ratio of a weakly acidic ion exchange resin plays a decisive role in the course of the LF over the service lifetime of the resin. The higher the H⁺ loading, the stronger the LF decrease in the filtrate will be compared to the LF in the raw water. Preferably, the (Na⁺ and/or K⁺)/H⁺ loading ratio is between 3:1 to 1:3, more preferably between 2:1 to 1:2, even more preferably between 1.5:1 to 1:1.5, and most preferably between 1.2:1 to 1:1.2. For the aforementioned loading ratios, a Na⁺/H⁺ loading is particularly preferred. The loading ratio is a ratio of moles of (Na⁺ and/or K⁺) to moles of H⁺. Another reaction that needs to be taken into account when interpreting the LF of filtered water of a weakly acidic ion exchange resin is the decomposition of the water (“autoprotolysis”), which specifically occurs at the beginning of the service life of an exchange resin. The exchange resin itself decomposes water into H⁺ and OH⁻ and then replaces the H⁺ with Na⁺. Thus, the LF from water changes to a higher LF due to an increase of the LF contributing ions Na⁺ and OH—.

In summary, at the beginning of the service life of a fresh Na⁺/H⁺ ion exchange resin the following processes essentially take place:
Exchange of 2Na⁺/Ea²⁺; this exchange is almost LF neutral.
Hydrolysis; i.e. the splitting of water into H⁺ and OH⁻ leading to an exchange of Na⁺ for H⁺ by the ion exchange resin; the resulting formation of Na⁺ and OH⁻ slightly increases the total LF value.
Also the exchange of H⁺ for Ca²⁺ may occur to a minor extent (at the beginning of the service life), which then also slightly reduces the LF again by the formation of H₂CO₃.

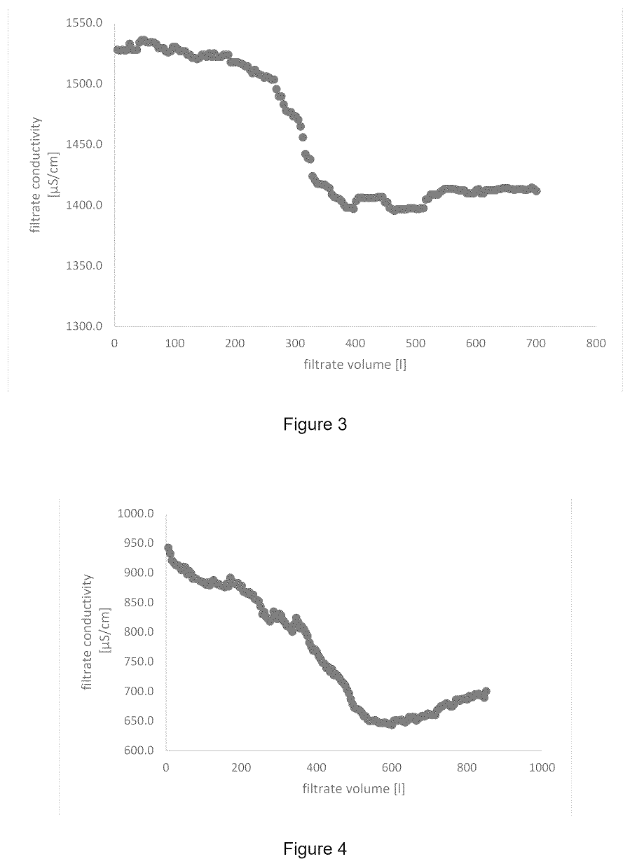

As a result, as illustrated in FIG. 3, the LF of the filtrate at the beginning of the resins life is either slightly higher or slightly lower than the LF of the raw water, depending on the H⁺-loading of the resin and the contribution of “autoprotolysis”.

As illustrated in FIG. 4, depending on the GH and KH proportions in the water, the conductivity (LF) in the filtrate will then decrease with increasing lifetime (volume of softened water) due to the increasing proportion of the H⁺/Ca²⁺ exchange of the KH until only this H⁺/Ca²⁺ exchange takes place at the end of the service life. This is because the Na⁺ exchange is preferred over the H⁺ exchange, so that the latter remains after the Na⁺ is exhausted. Once also the H⁺ resin is close to be exhausted, the exchange resin is close to be exhausted and the conductivity (LF) rises again due to the ions of GH and KH of the raw water.

Thus, in the exemplary diagrams of FIGS. 3 and 4, which show the conductivity (LF) of the softened water vs. the volume of softened water, the conductivity (LF) in the beginning decreases at a low to moderate slope which reflects the ongoing 2Na+/Ea²⁺ exchange. The diagram of FIG. 3 was obtained by carrying out the present method with a BRITA PURITY C 150 Finest ion exchange resin cartridge, wherein the tap water which was filtered with said ion exchange resin cartridge had a total hardness (GH) of 27° dH and a temporary hardness (KH) of 5° dH. The diagram of FIG. 4 was obtained by carrying out the present method with a BRITA PURITY C 150 Finest ion exchange resin cartridge, wherein the tap water which was filtered with said ion exchange resin cartridge had a total hardness (GH) of 20° dH and a temporary hardness (KH) of 10° dH. By carrying out a multitude of experiments with commercial ion exchange filter cartridges of BRITA of the so-called PURITY C Finest series and by applying steps i) and ii) according to the present method and analyzing the resulting measured data points and polynomials approximated between these experimental data points, it was surprisingly found that the inflection point IP can be determined either by step iii)α) or step iii)β), wherein IP obtained therewith allows to calculate RLV in step iv). The alternative steps iii)α) or iii)β) both allow a reliable IP determination.

Determination of Inflection Point IP (V_{IP}, w_{IP}) by Means of Step iii)α)

In step iii)α), after each polynomial approximation in step ii), the polynomial is analyzed for an inflection point IP (V_{IP}, w_{IP}) which corresponds to a point (V_{Si}, w_{app_i}) of the polynomial being a point approximated for (V_{Si}, wᵢ) in step ii), wherein at point (V_{Si}, w_{app_i}), a difference Δw between w_{app_1} of point (V_{Si}, w_{app_S1}) of the polynomial being a point approximated for (V_{Si}, wᵢ) in step ii) and w_{app_i} of point (V_{Si}, w_{app_i}) of the polynomial is ≥50 μS/cm for w being electrical conductivity LF or is ≥1.5 for w being pH.

Preferably, in step iii)α), said difference Δw is ≥55 μS/cm for w being electrical conductivity LF or is ≥1.65 for w being pH, most preferably said difference Δw is ≥60 μS/cm for w being electrical conductivity LF or is ≥1.8 for w being pH.

Even though different threshold values may be selected for difference Δw, namely for w being electrical conductivity ≥50 μS/cm, preferably ≥55 μS/cm and most preferably ≥60 μS/cm, and for w being pH≥1.5, preferably ≥1.65, most preferably ≥1.8, with all different threshold values, an inflection point IP can be reliably obtained. This is because already the smallest threshold values for difference Δw, namely ≥50 μS/cm for w being electrical conductivity and ≥1.5 for w being pH, indicate a significant change of conductivity and pH respectively, which change indicates that the Na⁺ resin is close to its exhaustion point and the H⁺ exchange starts to dominate. When inserting V_{IP} obtained by means of step iii)α) in below described formula (IV), filter exhaustion factor FA can be determined. The aforementioned smaller thresholds for difference Δw are obtained at lower volume values for V_{IP}. With said lower values obtained for V_{IP}, in turn, lower filter exhaustion factors FA are obtained. It was experimentally found that surprisingly, even with the aforementioned smallest threshold values for difference Δw, namely ≥50 μS/cm for w being electrical conductivity and ≥1.5 for w being pH, reliable RLV values can be obtained.

It was surprisingly found by a multitude of experiments that when determining inflection point IP (V_{IP}, w_{IP}) by means of step iii)α), that in case the above defined difference Δw is ∝60 μS/cm for w being electrical conductivity LF or is ≥1.8 for w being pH, the determination of inflection point IP and in turn of RLV is particularly reliable.

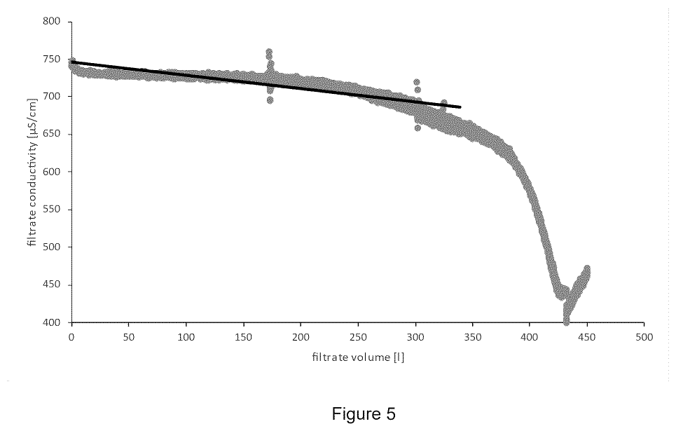

FIG. 5 exemplary shows the determination of inflection point IP (V_{IP}, w_{IP}) by means of step iii)α) according to the present method. In the diagram of FIG. 5, a polynomial of first order (see black straight line) is approximated between the data points measures in step ii), which data points are indicated in grey. The first measured volume V_{S1} is ≥4 l, wherein w_{app_1} of point (V_{Si}, w_{app_1}) of the polynomial is 745, 19 μS/cm, and at a filtrate volume V_{S1} of 342 l, w_{app_i} of point (V_{Si}, w_{app_i}) of the polynomial is ≥685, 13 μS/cm. Hence, the difference Δw is ≥60.06 μS/cm here. Thus, at (V_{Si}, w_{app_i}), the difference Δw is ≥60 μS/cm for w being electrical conductivity LF, which is the particularly preferred difference Δw, for the first time during carrying out steps i) to iv), and hence, the IP is reached at (V_{Si}, w_{app_i}). It is noted that after IP is determined in step iii)α), RLV can be calculated according to step iv), and thus, the method can be ended/stopped when inflection point IP is reached. However, in FIG. 5, for analysis purposes, measurement of datapoints according to step i) was carried out further after the IP was reached. For the IP determination depicted in FIG. 5, a BRITA PURITY C150 Finest ion exchange filter cartridge was used, which has a maximum volume capacity V_{cmax} of 1833 l. The tap water which was filtered with said ion exchange resin cartridge had a total hardness (GH) of 18° dH and a temporary hardness (KH) of 13° dH.

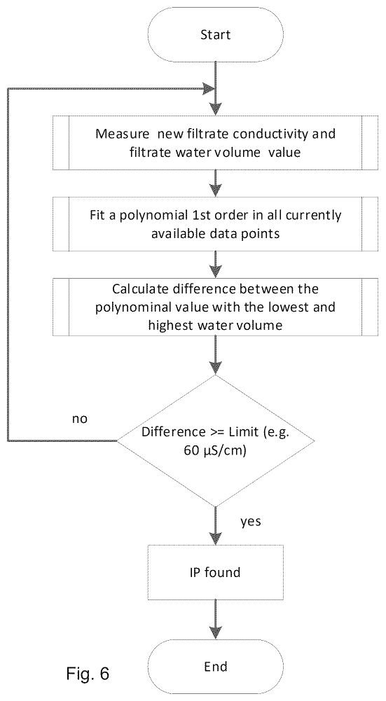

FIG. 6 depicts a flow chart of a particularly preferred determination of the inflection point IP according the present method applying step iii)α), in which a difference Δw between w_{app_1} and w_{app_i} being e.g. ≥60 μS/cm, which is the particularly preferred difference Δw, is determined for w being electrical conductivity LF for the first time during carrying out of steps i) to iv), and thus, the IP is reached. This determination of IP by means of difference Δw is also applicable when in the present method, pH is measured as water characteristic w, wherein in this case, e.g. the particularly preferred difference Δw being 1.8 for the first time during carrying out of steps i) to iv) may indicate inflection point IP.

Determination of Inflection Point IP (V_{IP}, w_{IP}) by Means of Step iii)β)

Alternatively to step iiia), step iii)β) may be applied for determination of the inflection point IP. In step iii)β), after each polynomial approximation in step ii), the polynomial is analyzed for an inflection point IP (V_{IP}, w_{IP}) which corresponds to a point where the second derivative of the polynomial is 0 or where there is a change of sign of the second derivative from positive to negative or from negative to positive. That is, the inflection point determined according to step iii)β) represents an inflection point in the mathematical sense, i.e. a point at which the curvature of a polynomial changes.

The second derivative is a derivative in the mathematical sense of differential calculus.

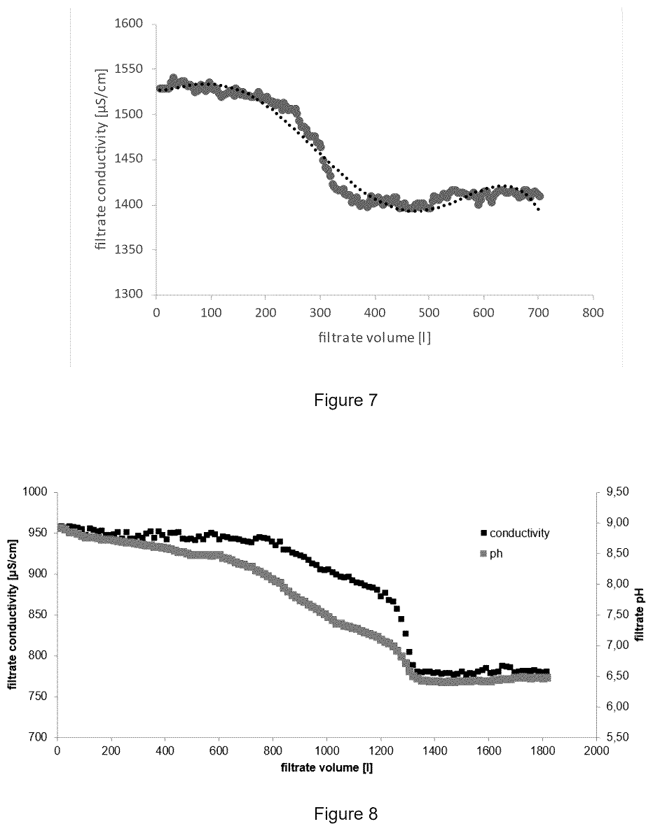

FIG. 7 exemplary shows the determination of inflection point IP (V_{IP}, w_{IP}) by means of step iii)β) according to the present method. In the diagram of FIG. 7, a polynomial of 5th order (see black dotted line) is approximated between the data points measures in step ii), which data points are indicated in grey. The diagram of FIG. 7 was obtained by carrying out the present method with a BRITA PURITY C 150 Finest ion exchange resin cartridge, wherein the tap water which was filtered with said ion exchange resin cartridge had a total hardness (GH) of 27° dH and a temporary hardness (KH) of 5° dH. As can be gathered from FIG. 7, once the Na⁺ capacity of the Na⁺/H⁺ exchange resin comes closer to its exhaustion point the LF starts to decrease with further increasing volume until a sharp decrease in the conductivity with further increasing volume of water which has passed through the exchange resin can be observed. This decrease stops when most of the H⁺ capacity is saturated, too. Then, the conductivity increases due to more and more raw water which can be seen in the filtrate. As exemplarily shown in FIG. 7, when calculating a polynomial fit into the measured curve, an inflection point (IP) can be seen near the water volume of 300 l. This inflection point can be derived according to step iii)β) by making a second derivative of the fitted curve formula. Because due to the discontinuous measurement curve it is not likely that the second derivative of the polynomial is exactly 0 at the IP. Therefore, preferably, a change of sign of the second derivative from negative to positive is used as an indication of the IP. In case the aforementioned conditions for said second derivative are obtained for the first time during carrying out of steps i) to iv), the inflection point IP is reached. It is noted that after IP is determined in step iii)β), RLV can be calculated according to step iv), and thus, the method can be ended/stopped when inflection point IP is reached. However, in FIG. 7, for analysis purposes, measurement of datapoints according to step i) was carried out further after the IP was reached-—e.g., at V=407 l where w=1405 μm, the exhaustion point of the ion exchange resin was reached.

The IP indicates, as described above, that the Na+ resin is close to its exhaustion point and the H+ exchange starts to dominate. From that point it can be experimentally derived how much capacity is left until the filter cartridge reaches its exhaustion point. Depending on the ratio between Na⁺/H⁺, the remaining capacity can vary in a wide range.

It can be seen, that the inflection point already can be detected, even when only a few additional data points to higher volumes are known. Consequently, the IP can be detected, either by means of step iii)α) or step iii)β), even if the filter still is in use, and in step iv), a remaining volume (RLV) may be calculated based on V_{IP} of the inflection point.

Thus, in the method of the present invention, the RLV can be determined from an analysis of the measured LF vs. softened water volume. It is to be understood that instead of the electrical conductivity other water characteristics which are also based on the measurements of electrical conductivity, e.g. the pH value, can be used instead. An example for pH is shown in FIG. 8.

FIG. 8 exemplarily shows that in step i), as a water characteristic w, besides of the electrical conductivity LF (indicated in dark grey), likewise, pH (indicated in light grey) may be measured. The diagram of FIG. 8 was obtained by carrying out the present method with a BRITA PURITY C 500 Finest ion exchange resin cartridge, wherein the tap water which was filtered with said ion exchange resin cartridge had a total hardness (GH) of 20° dH and a temporary hardness (KH) of 5° dH. In FIG. 8, for the same experimental example, the curves obtained from measurement of LF and pH are very similar at the beginning starting from V being 0 l and at the end when the filter is exhausted. Although the curve's shape differs in the middle part, the decreasing parts between around 1250-1300 l for measured pH and around 1200-1350 l for measured conductivity can clearly be seen. Since the decreasing parts overlap within similar value ranges, IP can be determined in step iii) for both w being electrical conductivity LF and w being pH. That is, the method works with measurement in step i) of both electrical conductivity and pH. This is no surprise, since it is known in the art of water chemistry that the pH value affects the water's conductivity. Therefore, IP determination by means of step iii)α) and step iii)β) is also possible when measuring pH as water characteristic w, wherein it was experimentally found that for the IP determination according to step iii)α), the difference Δw being 1.8 for w being pH is particularly preferred.

In the present method of determining the remaining water volume (RLV) which can still be softened prior to the exhaustion of an ion exchange resin contained in a filter device, the determination comprises:
i) sequentially measuring a water characteristic w, wherein w is selected from one or more of pH and electrical conductivity LF, and wherein w is determined by a sensor in softened water obtained from the filter device, at increments of softened water volume (V_{S}) to acquire measured data points (V_{Si}, wᵢ) with i=1, 2, 3, . . . , N and N ∈ [symbol] ;
ii) after each measuring of a sequential data point (V_{Si}, wᵢ) in step i) which data point is defined as new data point, a polynomial is approximated between all previously measured data points (V_{Sp}, wₚ) with p=1, 2, . . . i-1, and the new data point (V_{Si}, wᵢ);
iii) after each polynomial approximation in step ii), the polynomial is analyzed for an inflection point IP (V_{IP}, w_{IP}) which corresponds to a point:
   α) α) (V_{Si}, w_{app_i}) of the polynomial being a point approximated for (V_{Si}, wᵢ) in step ii), wherein at point (V_{Si}, w_{app_i}), a difference Δw between w_{app_1} of point (V_{Si}, w_{app_S1}) of the polynomial being a point approximated for (V_{Si}, wᵢ) in step ii) and w_{app_i} of point (V_{Si}, w_{app_i}) of the polynomial is ≥50 μS/cm for w being electrical conductivity LF or is ≥1.5 for w being pH; or
   β) where the second derivative of the polynomial is 0 or where there is a change of sign of the second derivative from positive to negative or from negative to positive;
iv) repeating steps ii) and iii) with the next higher i, and when an inflection point is determined in step iii), RLV is calculated based on V_{IP} of the inflection point IP.

In the method according to the invention, approximating a polynomial means polynomial interpolation of the given data point set (V_{Si}, wᵢ) with i=1, 2, 3, . . . , N by a polynomial of a degree (also called “order”) that passes through the points of the dataset (see e.g. https://en.wikipedia.org/wiki/Polynomial_interpolation). The degree of the polynomial selected for approximation according to step ii) may be as low as suitable for step iii) as long as said degree still provides a reliable determination of the inflection point IP. It was found that for steps iii)α) and iii)β), different degrees of polynomial are preferable.

For the inflection point determined by means of step iii)α), it is preferred that the polynomial is a 1^{st} to 4^{th} degree polynomial, more preferably 1^{st} or 3^{rd} degree polynomial, most preferably a 1^{st} degree polynomial.

For the inflection point determined by means of step iii)β), it is preferred that the degree of the polynomial is 4 to 8, more preferred 5 or 6 and most preferred the degree is 5.

In step iii), determination of the inflection point IP is performed:
α) By observing when at point (V_{Si}, w_{app_i}) of the polynomial being a point approximated for (V_{Si}, wᵢ) in step ii), a difference Δw between w_{app_1} of point (V_{Si}, w_{app_S1}) of the polynomial being a point approximated for (V_{Si}, wᵢ) in step ii) and w_{app_i} of point (V_{Si}, w_{app_i}) of the polynomial is ≥50 μS/cm for w being electrical conductivity LF or is ≥1.5 for w being pH; or β) by forming the second derivative of the polynomial; the point where this second derivative is 0 or where there is a change of sign of the second derivative from positive to negative or from negative to positive constitutes an inflection point IP.

According to step iv), when an inflection point is determined in step iii), RLV is calculated based on V_{IP} of the inflection point IP. RLV may be calculated based on the water volume V_{IP} measured at the inflection point IP according to the aforementioned formula (I):

$$RLV = {V}_{IP} * f , \qquad ( I )$$

wherein f is the remaining capacity factor. The remaining capacity factor f depends on the ion exchange resin's Na⁺/H⁺ loading ratio, as well as on which kind of step is applied for determination of V_{IP} the inflection point IP, namely whether step iii)α) or iii)β) is applied.

For example, formula (I) can be derived using filter parameters “FA” and “ [symbol] ”. FA is the filter exhaustion factor indicating which proportion of the filter's ion exchange resins capacity is exhausted, wherein FA is a value within the following range: 0.0<FA<1.0. By carrying out a multitude of experiments with commercial ion exchange filter cartridges of BRITA of the so-called PURITY C Finest series by applying steps i), ii) and iii) according to the present method, inflection points IP were obtained with step iii)α) or step iii)β). V_{IP} of the experimentally obtained inflection points IP were divided by the volume capacity V_{c_@total hardness} of the ion exchange resin for the water applied, as shown in formula (IV):

$$FA = {V}_{IP} / {V}_{c\_ @ total hardness} \qquad ( IV )$$

It is noted that V_{c_@total hardness} is the volume capacity of the ion exchange resin obtained for water having a certain water total hardness applied to the ion exchange resin until the ion exchange resin reaches its exhaustion point. V_{c_@total hardness} of the ion exchange resin depends on the (Na⁺ and/or K⁺)/H⁺ loading ratio of the ion exchange resin as well as on the amount of ion exchange resin contained in the filter device. For example, for BRITA's commercial PURITY C Finest filter cartridges, V_{c_@total hardness} is indicated in the example. After calculating a multitude of FA values for V_{IP} obtained by means of the present method's step iii)α) and iii)β) respectively, it was surprisingly found that independent from the size/capacity of ion exchange resin applied, e.g. irrespective whether a small PURITY C Finest filter cartridges of type C150 or a big one of type C1100 was applied, for all experimentally tested PURITY C Finest filter cartridges, to which water having different total water hardness was applied, an averaged FA was obtained for V_{IP} obtained by means of step iii)α) and for V_{IP} of the inflection point IP obtained by means of step iii)β), respectively. Namely, for V_{IP} obtained by means of step iii)α) with the particularly preferred difference Δw being ≥60 μS/cm for w being electrical conductivity LF a FA=0.60 was empirically found, and for V_{IP} obtained by means of step iii)β) a FA=0.76 was empirically found, wherein a multitude of experimentally measured Vie values divided by V_{c_@total hardness} according to formula (IV) were averaged in order to obtain the averaged FAs. [symbol] is the molar capacity of the filter (sum of Na⁺ (and/or K⁺) and H⁺ ion exchange resin) in [mmol].

RLV can then be calculated according to the formula (II)

$$RLV [ l ] = \frac{▼}{GH [ ∘ dH ] / 5.6} - {V}_{IP} \qquad ( II )$$

wherein GH can be calculated with the formula (III)

$$GH [ ∘ dH ] = \frac{5.6 * ▼ * FA}{{V}_{IP}} \qquad ( III )$$

It is to be understood that in formulae (II) and (III) other conversion factors than 5.6 can be used if other total hardness units, e.g. ° fH or [mmol] Ea²⁺ ions etc. are desired.

When inserting formula (III) into formula (II), formula (IIa) is obtained:

$$RLV [ l ] = \frac{{V}_{IP}}{FA} - {V}_{IP} = {V}_{IP} * ( \frac{1}{FA} - 1 ) \qquad ( IIa )$$

From formula (IIa) it can be seen that it is not necessary to know the total hardness (GH) of the water applied to the ion exchange resin, and it is also not necessary to know the molar capacity [symbol] of the filter, since both GH and [symbol] are truncated. Hence, with formula (IIa), RLV can be easily calculated based only on V_{IP} of the inflection point and FA.

When comparing formula (IIa) with formula (I), formula (Ia) can be derived:

$$f = \frac{1}{F A} - 1 \qquad ( Ia )$$

Factor f is the remaining capacity factor indicating which proportion of the filter's ion exchange resins capacity remains for softening the water at the inflection point IP. By inserting the aforementioned empirically found FA values into formula (Ia), namely FA=0.60 for V_{IP} obtained by means of step iii)α), and FA=0.76 for V_{IP} obtained by means of step iii)β), the respective factor f can be obtained. That is, f=0.67 for FA=0.60, and f=0.32 for FA=0.76.

In conclusion: In step iv), RLV may be calculated based on V_{IP} of the inflection point IP and filter exhaustion factor FA by means of formula (IIa)

$$RLV = {V}_{IP} * ( \frac{1}{FA} - 1 ) , \qquad ( IIa )$$

wherein filter exhaustion factor FA is a value within the following range: 0.0<FA<1.0; preferably FA is a value between 0.30 to 0.90, more preferably 0.50 to 0.85, even more preferably FA is a value between 0.50 to 0.70 for V_{IP} obtained by means of step iii)α and between 0.65 to 0.85 for V_{IP} obtained by means of step iii)β), yet even more preferably FA is between 0.55 to 0.65 for V_{IP} obtained by means of step iii)α and between 0.70 to 0.80 for V_{IP} obtained by means of step iii)β), and most preferably FA is 0.60 for V_{IP} obtained by means of step iii)α and FA is 0.76 for V_{IP} obtained by means of step iii)β). Filter exhaustion factor FA may be calculated with formula (IV):

$$FA = {V}_{IP} / {V}_{c\_ @ total hardness} , \qquad ( IV )$$

wherein V_{c_@total hardness} is the volume capacity of the ion exchange resin obtained for water having a certain water total hardness applied to the ion exchange resin until the ion exchange resin reaches its exhaustion point. Preferably, filter exhaustion factor FA is digitally stored in a memory, e.g. of an electronic control unit. The digitally stored FA is preferably provided by measuring an inflection point (IP) and dividing Vie of said inflection point by V_{c_@total hardness} according to formula (IV), wherein V_{c_@total hardness} is selected for the certain water total hardness applied to the ion exchange resin from a lookup table, e.g. a lookup table as shown in the present example, which lookup table may be digitally stored in a memory, e.g. of an electronic control unit, wherein a FA for V_{IP} obtained by means of step iii)α) is provided, and a FA for V_{IP} obtained by means of step iii)β) is provided. More preferably, FA is provided by measuring a plurality of inflection points (IP) and averaging the plurality of FAs calculated according to formula (IV), wherein an averaged FA for V_{IP} obtained by means of step iii)α) is provided, and an averaged FA for V_{IP} obtained by means of step iii)β) is provided.

Alternatively, in step iv), RLV may be calculated based on Vie of the inflection point IP and remaining capacity factor f by means of formula (I)

$$RLV = {V}_{IP} * f , \qquad ( I )$$

wherein remaining capacity factor f is a value between 0.01 and 99.0; preferably f is a value between 0.11 to 2.33, more preferably 0.18 to 1.0, even more preferably f is between 0.43 to 1.0 for V_{IP} obtained by means of step iii)α and between 0.18 to 0.54 for f obtained by means of step iii)β), yet even more preferably f is between 0.54 to 0.82 for V_{IP} obtained by means of step iii)α and between 0.25 to 0.43 for f obtained by means of step iii)β), and most preferably f is 0.67 for V_{IP} obtained by means of step iii)α) and f is 0.32 for V_{IP} obtained by means of step iii)β).

Although by the present experiments, for V_{IP} obtained by means of step iii)α), an FA=0.60 was empirically found, and for V_{IP} obtained by means of step iii)β), an FA=0.76 was empirically found, wherein the resulting factor f is 0.67 for V_{IP} obtained by means of step iii)α) and f is 0.32 for V_{IP} obtained by means of step iii)β), it is understood that e.g. due to possible error deviations and/or deviations in the ion exchange resin (Na⁺ and/or K⁺)/H⁺ loading ratio, FA and f may not be the exact aforementioned values, and thus may vary within a certain (error) margin. Such error margins may be reflected by the above indicated (yet) even more preferred value ranges. Alternatively, (error) deviations of FA and f may be expressed by a percentual deviation: The aforementioned, most preferred FA and f single values may vary within a margin of preferably ±10% of the FA or f value, and more preferably ±5% of the FA or f value: FA being 0.60±10% for V_{IP} obtained by means of step iii)α and FA being 0.76±10% for V_{IP} obtained by means of step iii)β), and f being 0.67±10% for V_{IP} obtained by means of step iii)α) and f being 0.32±10% for V_{IP} obtained by means of step iii)β); or yet most preferred FA being 0.60±5% for V_{IP} obtained by means of step iii)α and FA being 0.76±5% for V_{IP} obtained by means of step iii)β), and f being 0.67±5% for V_{IP} obtained by means of step iii)α) and f being 0.32±5% for V_{IP} obtained by means of step iii)β). E.g., FA being 0.60±10% means that FA is in a value range between 0.54 to 0.66.

The above described determinations of the inflection point IP and factors FA and f where experimentally obtained by carrying out the present method with BRITA's commercial PURITY C Finest filter cartridges, which preferably have a ion exchange resin Na⁺/H⁺ loading ratio between 1.5:1 to 1:1.5, and most preferably a ion exchange resin having a Na⁺/H⁺ loading ratio between 1.2:1 to 1:1.2. Therefore, in a particularly preferred embodiment of the present method, preferably a ion exchange resin Na⁺/H⁺ having a loading ratio between 1.5:1 to 1:1.5, and most preferably a ion exchange resin having a Na⁺/H⁺ loading ratio between 1.2:1 to 1:1.2, is applied.

If desired, also RLZ can be calculated. This requires the recording of time, e.g. the recording of V_{S} [I] at increasing increments of time e.g. [minute], [hour], [days] or [weeks] depending on the desired level of accuracy. An average water consumption dV_{average}[I/hour] can then be calculated, e.g. as arithmetic mean at any desired point in time during the use of the exchange resin, e.g. at the inflection point IP (dV_{average@IP}). RLZ can then be calculated according to the formula RLZ=RLV/dV_{average@IP}. It may even be desirable to take into account averages of 2, 3 or more weeks in order to smooth fluctuations which are due to single events like office/plant closures, company parties etc.

When applying step iii)β) for determining the IP, after a moderate positive or negative slope the polynomial reaches a first local maximum LM (V_{LM}, w_{LM}) and then typically proceeds with a negative slope until it reaches the characteristic sharp inflection point IP (V_{IP}, w_{IP}) with further increasing volume of water which has passed through the exchange resin (see FIG. 7, inflection point at water volume 300 l). Thus, the first local maximum LM (V_{LM}, w_{LM}) is located where the first derivative of the polynomial changes its sign from positive to negative, or the first derivative of the polynomial is zero (0) and the second derivate is smaller than 0. The first derivative is a derivative in the mathematical sense of differential calculus. Typically, the difference in conductivity LF (LFs) between the local maximum LM and the inflection point IP is within a range of preferably 4 to 1000 μS/cm, more preferably 6 to 800 μS/cm, and most preferably 10 to 300 μS/cm when using a typical Na+/H+ ratio as mentioned above.

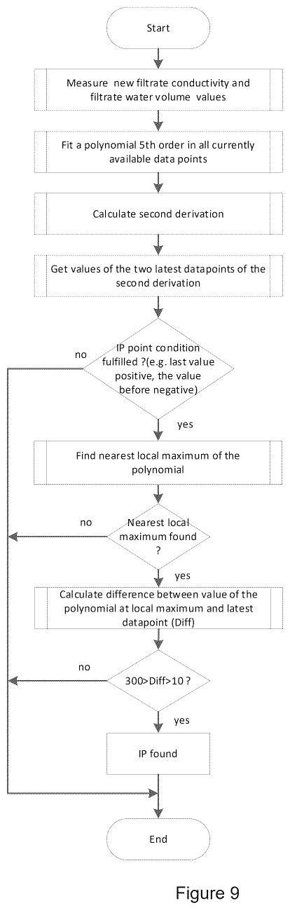

FIG. 9 depicts a flow chart of the alternative determination of the inflection point IP according to step iii)β) of the present method, in which a change of sign from positive to negative for the second derivative indicates inflection point IP. Then, optionally in addition, a local maximum near/adjacent to said IP may be determined, and the above difference in conductivity LF (LF_{δ}) between the local maximum LM and IP being preferably within a range of 4 to 1000 μS/cm, more preferably 6 to 800 μS/cm, and most preferably 10 to 300 μS/cm is determined. As explained above, a drop of LF to >1000, preferably >800 and most preferred >300 μS/cm is attributed to a change in raw water quality and is no IP.

In order to analyze the complete LF curve over the whole lifetime of the exchange resin, the conductivity preferably is measured at increments of softened water volume V_{S}. It is preferred that the larger the filter capacity, the larger is the volume increment of softened water after which the next LF is measured. As an example: for a maximum volume capacity V_{cmax} of less than 3750 liters, LF maybe measured every 0.5 l of softened water. For a filter capacity of between 3750 and 7850 liters, LF maybe measured every 1.0 l of softened water and for filter capacities larger than 7850 liters, LF maybe measured every 2.0 l of softened water. Preferably, increments of softened water volume V_{S}, or in other words volume intervals between V_{S1} and V_{Si+1} are within a range of 0.2 l to 2.5 l, more preferably within a range of 0.4 to 2.2 l, most preferably within a range of 0.5 l to 2.0 l.

Instead of in terms of liters, the increments of softened water volume V_{S} may alternatively be expressed in percentage of the maximum volume capacity V_{cmax} of the ion exchange resin. Preferably, the measurement of w selected from pH and/or LF is carried out at increments of softened water volume V_{S}, or in other words volume intervals between V_{S1} and V_{Si+1}, within a range of 0.01% to 0.5% of the maximum volume capacity V_{cmax} of the ion exchange resin, preferably within a range of 0.02% to 0.25% of the maximum volume capacity V_{cmax} of the ion exchange resin, more preferably within a range of 0.025% to 0.15% of the maximum volume capacity V_{cmax} of the ion exchange resin, and most preferably within a range of 0.03% to 0.1% of the maximum volume capacity V_{cmax} of the ion exchange resin. With these increments of softened water volume V_{S} (or in other words volume intervals between V_{S1} and V_{Si+1}), it is safeguarded that a reliable polynomial approximation is obtained in step ii). Because, if the volume intervals are too big, only few data points (V_{Si}, wᵢ) are measured, which would result in an inaccurate polynomial approximation.

Furthermore, it is preferred that the first measured volume V_{S1} is within a range of 0.01% to 0.5% of the maximum volume capacity V_{cmax} of the ion exchange resin, preferably within a range of 0.02% to 0.25% of the maximum volume capacity V_{cmax} of the ion exchange resin, more preferably within a range of 0.025% to 0.15% of the maximum volume capacity V_{cmax} of the ion exchange resin, and most preferably within a range of 0.03% to 0.1% of the maximum volume capacity V_{cmax} of the ion exchange resin. Especially for the IP determination according to step iii)α), it is important that V_{S1} is a volume relatively close to V=0 l to make it possible to accurately determine the IP by means of difference Δw, but on the other hand V_{S1} should not be too close to V=0 l, because too close to V=0 l, there might be disturbing factors which may be caused by different, unknown parameters, resulting in not plausible conductivity values in case V_{S1} is too close to V=0 l. If V_{S1} is too far from V=0 l, let's say e.g. 30% or 50% of the maximum volume capacity V_{cmax} of the ion exchange resin, then an alleged IP would be indicated too late and erroneously.

The term “maximum volume capacity V_{cmax} of the ion exchange resin” as used herein means the ion exchanges resin's maximal capacity for filtering water until the ion exchange resin reaches its exhaustion point, which maximal capacity is obtained when water of low total hardness, namely ≥4-6° dH, is applied to the ion exchange resin. The “maximum volume capacity V_{cmax} of the ion exchange resin” depends on the (Na⁺ and/or K⁺)/H⁺ loading ratio of the ion exchange resin as well as on the amount of ion exchange resin contained in the filter device. For example, for BRITA's commercial PURITY C Finest filter cartridges, maximum volume capacity V_{cmax} is indicated in the example.

The number of measurement points (V_{Si}, wᵢ), of course, depends on the memory capacity of the electronic control unit which is used in the water softening system. As an alternative to the storage of the complete LF curve over the whole lifetime of the exchange resin, e.g. in case of a more limited memory capacity, for example only the last 5 measurement points, preferably only the last 25 measurement points, more preferably only the last 50 points and most preferred only the last 250 measurement points of the LF curve can be stored in the memory of the electronic control unit. An alternative for working on the original measured data is using smoothed data sets. Only one method should be mentioned here. Shift registers with nominal capacities of 5 to 251 are preferably used.

Typically, a shift register is used as memory, where the measurement points are added to the register until the register has reached its nominal capacity. The next measurement point which is then to be stored either deletes the oldest measurement point from the register and adds itself as latest measurement point or causes all previous measurement points to be deleted from the register and starts a fresh register. When the shift register has reached the nominal capacity an arithmetic average or median of each shift register set of datapoints is calculated and stored together with the water volume value of the latest point. The first part of the conductivity/volume curve at the beginning of the filtration with a fresh ion exchange resin is hard to predict (as described above) and depends on a lot of parameters, which are typically not known when the filter cartridge is used. Nevertheless, it is known from experiments that the behavior of the conductivity/volume curve at the beginning of the filtration does not influence the RLV of the filter. However, different behavior at the beginning of filtration, which may be caused by different, unknown parameters, disturbs the polynomial fitting. To avoid this disturbing influence, a straight line L₁ having a slope sl₁ may be fitted between the first measured data points within a range V_{Si}=0 up to a threshold Volume V_{T}. The slope sl₁ of this line L₁ is about zero (0), i.e. it can vary within ±10%, preferably ±5%, more preferred 1%, wherein in this context, the percental values mean a slope expressed in percentage. That is, a slope sl₁ varying within ±10% is a slope between − 1/10 and + 1/10, a slope sl₁ varying within ±5% is a slope between− 1/20 and + 1/20, and a slope sl₁ varying within ±1% is a slope between− 1/100 to + 1/100. The aforementioned numerical values expressed in terms of fractions, here 1/10, 1/20 and 1/100, express the ratio of the legs of a slope triangle of a line, here the straight line L₁ having a slope sl₁. A slope triangle is a right triangle that has its hypotenuse on the line that contains it, in this case the straight line L₁. The slope triangle has two legs parallel to the axes of a coordinate system, one leg runs vertically, the other horizontally, wherein the slope is expressed by the ratio of the length of the leg running vertically to the length of the leg running horizontally. E.g., for a slope 1/10, the length of the leg running vertically is 1 wherein the length of the leg running horizontally is 10. A slope of a line is positive in case y value, which is indicated on ordinate of a coordinate system, always increase when x value, which is indicated on abscissa of the coordinate system, increases, while the slope is negative in case y value always decreases when x increases. It is preferred that the polynomial approximation according to step ii) is applied to straight line L₁. This means that in step ii), for V_{S1}>V_{T}, the polynomial is approximated between all previously measured data points (V_{Sp}, wₚ) with p=1, 2, . . . i-1 and the new data point (V_{Si}, wᵢ), and for V_{S1} s V_{T}, the aforementioned polynomial is approximated through the straight line L₁. Thereby, one approximated polynomial is obtained.

The threshold volume V_{T} is typically within a range of up to 5% of the maximum volume capacity V_{cmax} of the ion exchange resin, preferably up to 4%, more preferably up to 2%, and most preferably ≥1.5%. V_{cmax} is the volume of the ion exchange resin which has been softened before the total hardness GH in the filtrate reaches a value of ≤6° dH half of the GH value in the raw water. Hence, preferably, “first measured data points” represent data points within the range of 0 l to V_{T} as described above.

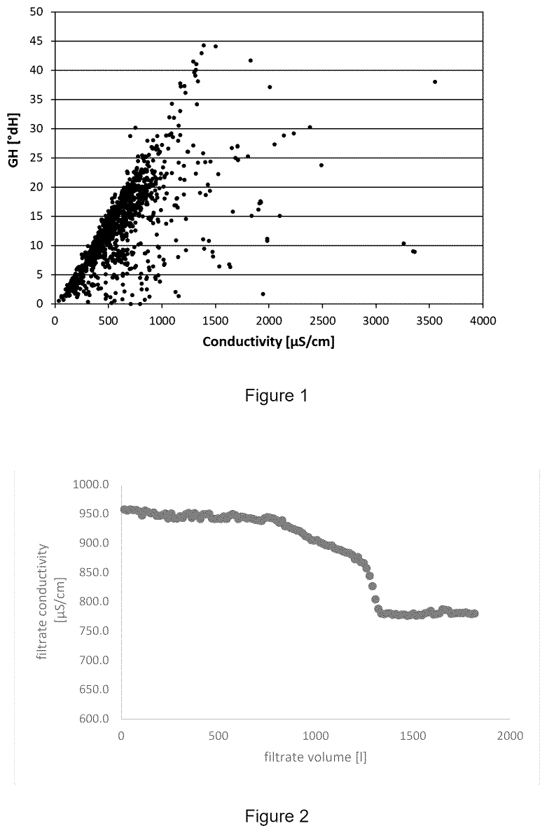

Thus, the electrical conductivity LF of the filtered (i.e. softened) water (V_{S}) is measured at increasing increments of softened water volume (V_{S}), and the LF values are then recorded as a function of the volume of softened water V_{S}, resulting in a LF vs. softened water volume curve, as illustrated in FIG. 2.

The above described calculations can be performed using conventional programmable electronic devices in combination with a memory device, e.g. a dynamic memory device, in which the data pairs of LF and water volume, and optionally the time are—at least temporarily—stored. The memory may, of course, also be an integral part of the programmable device; preferably a shift register is used as memory.

The method according to the present invention is broadly applicable even in situations of varying water qualities (varying KH, GH). As outlined above, the decrease in conductivity after the initial low to moderate decline is dependent on the KH. In cases of raw water with a low KH the corresponding conductivity decrease is lower than in cases with raw water of higher KH. Yet, it was found that even in case of a raw water with a KH of as low as 2° dH a decrease of about 70 μS/cm is still detectable, so that a reliable indication of remaining volume (RLV) can be made with the method according to the invention. If the Na+/H+ ratio is in a above mentioned preferred ratio and a LF drop of >1000, preferably >800 and most preferred >300 μS/cm is observed between the LF at the detected local maximum and the possible IP determined according to step iii)b), this drop is attributed to a change in raw water quality and is no IP. Yet, changes in the water quality are rare, and if they occur they extend over a range of one day up to several weeks after which the water quality typically returns to its initial quality over a period of several months. Thus, within the lifetime of a typical ion exchange resin used in the present invention in the worst case two changes in the water quality of the raw water can be expected. But even then at least the remaining volume (RLV) can always be reported.

In a further embodiment the invention relates to a water softening system. The water softening system may comprise:
I. An inlet for influent raw water and
II. an outlet for effluent softened water,
III. an ion exchange device loaded with an ion exchange resin,
IV. an electronic device capable of receiving signals emitted
   a) by a sensor for the water characteristic w, which is selected from one or more of the electrical conductivity (LF) and the pH, wherein the sensor is arranged in the softened water outlet and which signal is selected from one or more of the electrical conductivity (LF) and the pH and
   b) by a volume meter for measuring the volume flow of softened water, likewise arranged in the softened water outlet which signal is the flowed softened water volume (V_{S}), which volume meter is optionally coupled with an hour or minute meter, and
V. an interface for transmitting the signals received under IVa) and IVb) to an electronic control unit; and
VI. an electronic control unit,
wherein the electronic control unit has a memory to:
I. store the repeatedly/sequentially measured water characteristic w, which is selected from one or more of the electrical conductivity LF and the pH of the filtered (i.e. softened) water at increments of softened water volume (V_{S}), received from the interface to acquire measured data points (V_{Si}, wᵢ) with i=1, 2, 3, . . . , N and N ∈ [symbol] ; and
II. store an executable computer program which is capable of executing the following method steps:
   a. after each storing of a sequential data point (V_{Si}, wᵢ) in step I) which data point is defined as new data point, approximating a polynomial between all previously measured data points (V_{Sp}, wₚ) with p=1, 2, . . . i-1, and the new data point (V_{Si}, wᵢ);
   b. after each polynomial approximation in step IIa), analyzing the polynomial for an inflection point IP (V_{IP}, w_{IP}) which corresponds to a point where:
      α) (V_{Si}, w_{app_i}) of the polynomial being a point approximated for (V_{Si}, wᵢ) in step ii), wherein at point (V_{Si}, w_{app_i}), a difference Δw between w_{app_1} of point (V_{S1}, w_{app_S1}) of the polynomial being a point approximated for (V_{S1}, wᵢ) in step ii) and w_{app_i} of point (V_{Si}, w_{app_i}) of the polynomial is ≥50 μS/cm for w being electrical conductivity LF or is ≥1.5 for w being pH; or
      β) where the second derivative of the polynomial is 0 or where there is a change of sign of the second derivative from positive to negative or from negative to positive;
c. repeating steps Ila) and IIb) with the next higher i, and when an inflection point is determined in step IIb), RLV is calculated based on V_{IP} of the inflection point IP.

In said water softening system, in the executable computer program, the method steps described above and/or defined in the subclaims relating to the present method may be applied. This means that features described for any one of steps ii), iii) and iv) of the method may likewise be applied in the computer program according to any one of steps Ila), IIb) and IIc), respectively.

RLV and optionally RLZ can be calculated as described above for the present method for determining the remaining water volume in a water softening systems using H⁺/(Na⁺ and/or K⁺)-exchange resins, preferably H⁺/Na⁺-exchange resins.

The electronic control unit may further have means for communicating RLV and optionally RLZ to a user, e.g. by way of an optical display or an acoustic signal or by transmitting RLV and optionally RLZ to a remote location e.g. via LAN/WLAN/Inter-net; optionally the data can also be stored in a “cloud” and downloaded at the request of a user and then be displayed via a portal.

In a further embodiment the invention relates to a computer program and a computer readable medium. The computer program according to the present invention comprises instructions to cause the water softening system according to the present invention to execute the steps of the method according to the present invention. The computer readable medium according to the present invention has stored thereon the computer program according to the invention.

### Example

For the present method for determining the remaining water volume in a water softening systems using H⁺/Na⁺-exchange resins, commercial ion exchange filter cartridges of BRITA of the so-called PURITY C Finest series were applied. Different types of PURITY C Finest filter cartridges exist, namely e.g. types C150, C300, C500, C1100, which differ in their capacity for filtering water until the ion exchange resin is exhausted. The ion exchange resins of these filter cartridges are weakly acidic ion exchange resins having a Na⁺/H⁺ loading within the above described preferred Na⁺/H⁺ loading ratios, such that they provide a capacity as shown in the following table. It is noted that this table is disclosed in the instruction manual of the cartridge for the user's information, and the data of this table may be digitally stored in a memory of a filter head of the cartridge, such that the capacity information can be used for the present method.

It is noted that in the table below, the maximum volume capacity V_{cmax} of the ion exchange resin is the filter capacity indicated for the total hardness 4-6° dH. That is, for PURITY C Finest C150 V_{cmax} is 1833 l, for C300 it is 3000 l, for C500 it is 5690 l and for C1100 it is 10000 l.

Furthermore, in the table below, V_{c_@total hardness} being the volume capacity of the ion exchange resin obtained for water having a certain water total hardness applied to the ion exchange resin until the ion exchange resin reaches its exhaustion point is listed. E.g., V_{c_@total hardness} for a total water hardness of 20° dH is 1707 l for PURITY C Finest C500 or 550 l for PURITY C Finest C150.

| | |
|---|---|
| °dH | PURITY C Finest - Filter capacity in liters |

| (°GH) | C150 | C300 | C500 | C1100 |
|---|---|---|---|---|
| 4 | 1833 | 3000 | 5690 | 10000 |
| 5 | 1833 | 3000 | 5690 | 10000 |
| 6 | 1833 | 3000 | 5690 | 10000 |
| 7 | 1571 | 2571 | 4877 | 8571 |
| 8 | 1375 | 2250 | 4268 | 7500 |
| 9 | 1222 | 2000 | 3793 | 6667 |
| 10 | 1100 | 1800 | 3414 | 6000 |
| 11 | 1000 | 1636 | 3104 | 5455 |
| 12 | 917 | 1500 | 2845 | 5000 |
| 13 | 846 | 1385 | 2626 | 4615 |
| 14 | 786 | 1286 | 2439 | 4286 |
| 15 | 733 | 1200 | 2276 | 4000 |
| 16 | 688 | 1125 | 2134 | 3750 |
| 17 | 647 | 1059 | 2008 | 3529 |
| 18 | 611 | 1000 | 1897 | 3333 |
| 19 | 579 | 947 | 1797 | 3158 |
| 20 | 550 | 900 | 1707 | 3000 |
| 21 | 524 | 857 | 1626 | 2857 |
| 22 | 500 | 818 | 1552 | 2727 |
| 23 | 478 | 783 | 1484 | 2609 |
| 24 | 458 | 750 | 1423 | 2500 |
| 25 | 440 | 720 | 1366 | 2400 |
| 26 | 423 | 692 | 1313 | 2308 |
| 27 | 407 | 667 | 1264 | 2222 |
| 28 | 393 | 643 | 1219 | 2143 |
| 29 | 379 | 621 | 1177 | 2069 |
| 30 | 367 | 600 | 1138 | 2000 |
| 31 | 355 | 581 | 1101 | 1935 |
| 32 | 344 | 563 | 1067 | 1875 |
| 33 | 333 | 545 | 1035 | 1818 |
| 34 | 324 | 529 | 1004 | 1765 |
| 35 | 314 | 514 | 975 | 1714 |

Besides of the aforementioned weakly acidic ion exchange resin providing the capacities indicated in this table, the filter cartridges of BRITA's PURITY C Finest series further comprise a charcoal filter providing for further filtration effects such as mechanical filtration of the water to be filtered as well as removal of undesired coloring and/or odors of the water to be filtered. However, the charcoal filter's characteristics are irrelevant for the present method.

What is claimed is:

1. A method of determining the remaining water volume (RLV) which can still be softened prior to the exhaustion of an ion exchange resin contained in a filter device, the determination comprising the steps of:
i) sequentially measuring a water characteristic w, wherein w is selected from one or more of pH and electrical conductivity LF, and wherein w is determined by a sensor in softened water obtained from the filter device, at increments of softened volume (V_{S}) to acquire measured data points (V_{Si}, wᵢ) with i=1, 2, 3, . . . , N and N ∈ [symbol] ;
ii) after each measuring of a sequential data point (V_{Si}, wᵢ) in step i) which data point is defined as new data point, a polynomial is approximated between all previously measured data points (V_{Sp}, wₚ) with p=1, 2, . . . i-1, and the new data point (V_{Si}, wᵢ);
iii) after each polynomial approximation in step ii), the polynomial is analyzed for an inflection point IP (V_{IP}, w_{IP}) which corresponds to a point:
α) (V_{Si}, w_{app_i}) of the polynomial being a point approximated for (V_{Si}, wᵢ) in step ii), wherein at point (V_{Si}, w_{app_i}), a difference Δw between w_{app_1} of point (V_{S1}, w_{app_S1}) of the polynomial being a point approximated for (V_{S1}, w₁) in step ii) and w_{app_i} of point (V_{Si}, w_{app_i}) of the polynomial is ≥50 μS/cm for w being electrical conductivity LF or is ≥1.5 for w being pH; or
β) where the second derivative of the polynomial is ≥0 or where there is a change of sign of the second derivative from positive to negative or from negative to positive;
iv) repeating steps iii) and iii) with the next higher i, and when an inflection point is determined in step iii), RLV is calculated based on V_{IP} of the inflection point IP.

2. The method according to claim 1, wherein the method comprises at least one of the following features:
In step iii)α), said difference Δw is ≥55 μS/cm for w being electrical conductivity LF or is ≥1.65 for w being pH, most preferably said difference Δw is ≥60 μS/cm for w being electrical conductivity LF or is ≥1.8 for w being pH; and/or
the ion exchange resin has a (Na⁺ and/or K⁺)/H⁺ loading ratio between 3:1 to 1:3, more preferably between 2:1 to 1:2, even more preferably between 1.5:1 to 1:1.5, and most preferably between 1.2:1 to 1:1.2; and/or
V_{S1} is within a range of 0.22% to 5% of the maximum volume capacity V_{cmax} of the ion exchange resin, preferably within a range of 0.3% to 3% of the maximum volume capacity V_{cmax} of the ion exchange resin, more preferably within a range of 0.35% to 2% of the maximum volume capacity V_{cmax} of the ion exchange resin, and most preferably within a range of 0.4% to 1.5% of the maximum volume capacity V_{cmax} of the ion exchange resin; and/or
an increment of softened volume (V_{S}) is within a range of 0.01% to 0.5% of the maximum volume capacity V_{cmax} of the ion exchange resin, preferably within a range of 0.02% to 0.25% of the maximum volume capacity V_{cmax} of the ion exchange resin, more preferably within a range of 0.025% to 0.15% of the maximum volume capacity V_{cmax} of the ion exchange resin, and most preferably within a range of 0.03% to 0.1% of the maximum volume capacity V_{cmax} of the ion exchange resin.

3. The method according to claim 1, wherein in step ii), prior to approximating a polynomial between all previously measured data points (V_{Sp}, wₚ) and the new data point (V_{Si}, wᵢ), a straight line L₁ having a slope sl₁ is fitted between the first measured data points within a range V_{Si}=0 up to a threshold Volume V_{T}.

4. The method according to claim 3, wherein V_{T} is within a range of up to 5% of the maximum volume capacity V_{cmax} of the ion exchange resin, preferably up to 4%, more preferably up to 2%, and most preferably ≥1.5%.

5. The method according to claim 1, wherein a remaining filter life time (RLZ) is calculated by dividing RLV by an average water consumption dV_{average} of a water volume per hour.

6. The method according to claim 1, wherein for the inflection point IP (V_{IP}, w_{IP}) according to step iii)α), the polynomial is a 1^{st} to 4^{th} degree polynomial, preferably ≥1^{st} or 3^{rd} degree polynomial, most preferably a 1^{st} degree polynomial.

7. The method according to claim 1, wherein for the inflection point IP (V_{IP}, w_{IP}) according to step iii)β), the degree of the polynomial is 4 to 8, more preferred 5 or 6 and most preferred the degree is 5.

8. The method according to claim 1, wherein for the inflection point IP (V_{IP}, w_{IP}) according to step iii)β), a local maximum LM (V_{LM}, w_{LM}) adjacent to inflection point IP (V_{IP}, w_{IP}) is determined, wherein the difference between w_{IP} and w_{LM} is in a predetermined range w_{δ}, preferably the predetermined range w_{δ} is 4 to 1000 μS/cm, more preferably 6 to 800 μS/cm, and most preferably 10 to 300 μS/cm for the water characteristic w being electrical conductivity LF.

9. The method according to claim 8, wherein the local maximum LM (V_{LM}, w_{LM}) is a first derivative of the polynomial where there is a change of sign from positive to negative, or the first derivative of the polynomial is 0 and the second derivate is smaller than 0.

10. The method according to claim 1, wherein for the inflection point IP (V_{IP}, w_{IP}) according to step iii)β), for the water characteristic w being electrical conductivity LF, a drop above the preferred predetermined range, preferably >300 μS/cm between local maximum LM(V_{Lm}, w_{Lm}) adjacent to inflection point IP (V_{IP}, w_{IP}) and the infection point IP(V_{IP}, w_{IP}), is attributed to a change in raw water quality and is no IP.

11. A water softening system, comprising:
I. An inlet for influent raw water and
II. an outlet for effluent softened water,
III. a filter device containing an ion exchange resin,
IV. an electronic device capable of receiving signals emitted
a. by a sensor for measuring the water characteristic w, arranged in the softened water outlet which signal is selected from one or more of the electrical conductivity (LF) and the pH,
b. by a volume meter for measuring the volume flow of softened water likewise arranged in the softened water outlet which signal is the flowed softened water volume (V_{S}), which volume meter is optionally coupled with an hour and/or minute meter,
V. an interface for transmitting the signals received under IVa) and IVb) to an electronic control unit, and
VI. an electronic control unit,
, wherein the electronic control unit has a memory to:
I. store the repeatedly/sequentially measured water characteristic w, which is selected from one or more of the electrical conductivity LF and the pH of the filtered (i.e. softened) water at increments of softened water volume (V_{S}), received from the interface to acquire measured data points (V_{Si}, wᵢ) with i=1, 2, 3, . . . , N and N ∈ [symbol] ; and
II. store an executable computer program which is capable of executing the following method steps:
a. after each storing of a sequential data point (V_{Si}, wᵢ) in step I) which data point is defined as new data point, approximating a polynomial between all previously measured data points (V_{Sp}, wₚ) with p=1, 2, . . . i-1, and the new data point (V_{Si}, wᵢ);
b. after each polynomial approximation in step IIa), analyzing the polynomial for an inflection point IP (V_{IP}, w_{IP}) which corresponds to a point:
α) (V_{Si}, w_{app_i}) of the polynomial being a point approximated for (V_{Si}, wᵢ) in step ii), wherein at point (V_{Si}, w_{app_i}), a difference Δw between w_{app_1} of point (V_{S1}, w_{app_S1}) of the polynomial being a point approximated for (V_{S1}, w₁) in step ii) and w_{app_i} of point (V_{Si}, w_{app_i}) of the polynomial is ≥50 μS/cm for w being electrical conductivity LF or is 1.5 for w being pH;
β) where the second derivative of the polynomial is 0 or where there is a change of sign of the second derivative from positive to negative or from negative to positive;
c. repeating steps Ila) and IIb) with the next higher i, and when an inflection point is determined in step lib), RLV is calculated based on V_{IP} of the inflection point IP.

12. The water softening system according to claim 11, wherein
in the executable computer program, the method steps according to claim 2 are applied.

13. The water softening system according to claim 11, wherein the water softening system comprises at least one of the following features:
the electronic control unit has means for communicating RLV and/or RLZ to a user or by transmitting RLV to a remote location, optionally RLV and/or RLZ can also be stored in a “cloud” and downloaded at the request of a user and then be displayed via a portal; and/or
the memory includes a sl₁ ft register.

14. The computer program comprising instructions to cause the water softening system according to claim 11 to execute the steps of the method of determining the remaining water volume (RLV) which can still be softened prior to the exhaustion of an ion exchange resin contained in a filter device, the determination comprising the steps of:
i) sequentially measuring a water characteristic w, wherein w is selected from one or more of pH and electrical conductivity LF, and wherein w is determined by a sensor in softened water obtained from the filter device, at increments of softened volume (V_{S}) to acquire measured data points (V_{Si}, wᵢ) with i=1, 2, 3, . . . , N and N ∈ [symbol] ;
ii) after each measuring of a sequential data point (V_{Si}, wᵢ) in step i which data point is defined as new data point, a polynomial is approximated between all previously measured data points (V_{Sp}, wₚ) with p=1, 2, . . . i-1, and the new data point (V_{Si}, wᵢ);
iii) after each polynomial approximation in step ii), the polynomial is analyzed for an inflection point IP (V_{IP}, w_{IP}) which corresponds to a point:
α) (V_{Si}, w_{app_i}) of the polynomial being a point approximated for (V_{Si}, wᵢ) in step ii), wherein at point (V_{Si}, w_{app_i}), a difference Δw between w_{app_1} of point (V_{S1}, w_{app_S1}) of the polynomial being a point approximated for (V_{S1}, w₁) in step ii) and w_{app_i} of point (V_{Si}, w_{app_i}) of the polynomial is ≥50 μS/cm for w being electrical conductivity LF or is ≥1.5 for w being pH; or
β) where the second derivative of the polynomial is 0 or where there is a change of sign of the second derivative from positive to negative or from negative to positive;
iv) repeating steps ii) and iii) with the next higher i, and when an inflection point is determined in step iii), RLV is calculated based on V_{IP} of the inflection point IP.

15. A computer readable medium having stored thereon the computer program according to claim 14.

16. The method according to claim 2, wherein in step ii), prior to approximating data point (V_{Si}, wᵢ), a straight line L₁ having a slope sl₁ is fitted between the first measured data points within a range V_{Si}=0 up to a threshold Volume V_{T}., and wherein V_{T} is within a range of up to 5% of the maximum volume capacity V_{cmax} of the ion exchange resin, preferably up to 4%, more preferably up to 2%, and most preferably 1.5%.

17. The method according to claim 16, wherein a remaining filter life time (RLZ) is calculated by dividing RLV by an average water consumption dV_{average} of a water volume per hour, and wherein for the inflection point IP (V_{IP}, w_{IP}) according to step iii)α), the polynomial is a 1^{st} to 4^{th} degree polynomial, preferably 1^{st} or 3^{rd} degree polynomial, most preferably a 1^{st} degree polynomial.

18. The method according to claim 17, wherein for the inflection point IP (V_{IP}, w_{IP}) according to step iii)β), the degree of the polynomial is 4 to 8, more preferred 5 or 6 and most preferred the degree ≥5, wherein for the inflection point IP (V_{IP}, w_{IP}) according to step iii)β), a local maximum LM (V_{LM}, w_{LM}) adjacent to inflection point IP (V_{IP}, w_{IP}) is determined, and wherein the difference between w_{IP} and w_{LM} is in a predetermined range w_{δ}, preferably the predetermined range w_{δ} is 4 to 1000 μS/cm, more preferably 6 to 800 μS/cm, and most preferably 10 to 300 μS/cm for the water characteristic w being electrical conductivity LF.

19. The method according to claim 18, wherein the local maximum LM (V_{LM}, w_{LM}) is a first derivative of the polynomial where there is a change of sign from positive to negative, or the first derivative of the polynomial is 0 and the second derivate is smaller than 0, and wherein for the inflection point IP (V_{IP}, w_{IP}) according to step iii)β), for the water characteristic w being electrical conductivity LF, a drop above the preferred predetermined range, preferably >300 μS/cm between local maximum LM(V_{Lm}, w_{Lm}) adjacent to inflection point IP (V_{IP}, w_{IP}) and the infection point IP(V_{IP}, w_{IP}), is attributed to a change in raw water quality and is no IP.

20. The water softening system according to claim 12, wherein the water softening system comprises at least one of the following features:
the electronic control unit has means for communicating RLV and/or RLZ to a user or by transmitting RLV to a remote location, optionally RLV and/or RLZ can also be stored in a “cloud” and downloaded at the request of a user and then be displayed via a portal; and/or
the memory includes a shift register.
